(19) United States
(12) Patent Application Publication
(10) Pub. No.: US 2018/0025403 A1
(43) Pub. Date: Jan. 25, 2018

(54) ENABLING A MULTIPLE STORAGE MARKETPLACE THROUGH SELECTIVE PERMUTATION OF INHERITED STORAGE

(71) Applicants: GARY HOWARD MCKAY, CAMBERWELL (AU); REGAN JARROD MCKAY, GLEN IRIS (AU)

(72) Inventors: GARY HOWARD MCKAY, CAMBERWELL (AU); REGAN JARROD MCKAY, GLEN IRIS (AU)

(21) Appl. No.: 15/214,483

(22) Filed: Jul. 20, 2016

(51) Int. Cl. G06Q 30/06; G06Q 30/02

(52) U.S. Cl. CPC G06Q 30/0619; G06Q 30/0283

(57) ABSTRACT

Methods for enabling a multiple storage marketplace through selecting a permutation of inherited storage created in a tiered hierarchy mechanism through a topology of multiple hybrid cloud storage systems. Through those methods of permutation, a seamless mechanism of local storage, on-premises cloud and hybrid cloud storage management, a scalable configuration is achieved that enable a top-down flow of storage space accumulation throughout the topology. Any node in a particular topology space is capable of selecting a unique permutation that would hold for a particular session of storage space flow. Through those methods, a marketplace of storage space is created, thereby proliferating the topology of multiple hybrid cloud storage systems with ad-hoc permutation based selection of inherited storage spaces. The marketplace is independent of the storage system topology, number of nodes in the topology as well as the number of elements chosen in the permutation.

### SECTION 1.0 BACKGROUND

The advent of cloud-based computing architectures has opened new possibilities for the rapid and scalable deployment of virtual Web stores, media outlets, social networking sites, and many other on-line sites or services. In general, a cloud-based architecture deploys a set of hosted resources such as processors, operating systems, software and other components that can be combined together to form virtual machines. A user can request the instantiation of a virtual machine or set of machines from those resources from a central server or cloud management system to perform intended tasks, services, or applications. For example, a user may wish to set up and instantiate a virtual server from the cloud to create a storefront to market products or services on a temporary basis. The user can subscribe to the set of resources needed to build and run the set of instantiated virtual machines on a comparatively short-term basis, such as hours or days, for their intended application.

Typically, when a user utilizes a cloud, the user must track the software applications executed in the cloud and/or processes instantiated in the cloud. For example, the user must track the cloud processes to ensure that the correct cloud processes have been instantiated, that the cloud processes are functioning properly and/or efficiently, that the cloud is providing sufficient resources to the cloud processes, and so forth. Due in part to the user's requirements and overall usage of the cloud, the user may have many applications and/or processes instantiated in a cloud at any given instant, and the user's deployment of virtual machines, software, and other resources can change dynamically over time. In cases, the user may also utilize multiple independent clouds to support the user's cloud deployment. That user may further instantiate and use multiple applications or other software or services inside or across multiple of those cloud boundaries, and those resources may be used or consumed by multiple or differing end-user groups in those different cloud networks.

In addition, cloud platforms exist or are envisioned today in which the user's desired virtual machines and software are received from a cloud marketplace system. In a cloud marketplace system, the user can transmit a software request to a cloud marketplace system, which acts as an intermediary between the user and a set of marketplace clouds. The marketplace clouds can receive the user's software request (or request for other resources), and submit a bid to the cloud marketplace system to supply or fulfil the software specified by the user. The cloud marketplace system can be configured to select the fulfilment bid from the marketplace clouds that satisfies the user's software request at lowest cost, and/or based on other decision logic.

In cloud marketplace systems, the set of clouds which deliver or provision the user's requested software or other resources can change over time, due to various reasons. For one, the marketplace clouds themselves may alter or withdraw the applications or other software which they are offering to users of the marketplace. For another, the user may wish to update their requested software or change any selection criteria they wish to apply to fulfilment bids received from clouds in the marketplace. As such, the set of provisioning clouds that are actually delivering or supporting the user's software deployment and/or other resources can shift or change over time, as existing clouds drop out and/or new clouds are substituted. The user can thus be supported by a sequence or progression of different clouds selected from the cloud marketplace, over time.

In the face of a potentially ever-shifting sequence of provisioning clouds, it may be a practical difficulty or inconvenience for the cloud marketplace system and/or user to be presented with a series of new clouds with which to register, and from which to extract usage and subscription data for billing or other purposes. It may be desirable to provide systems and methods for cross-cloud vendor mapping service in a dynamic cloud marketplace, in which the task of registering, storing, and aggregating the user's software usage history can be performed by an external mapping service configured to capture that history across a series of different provisioning clouds at different times, and aggregate billing and subscription data across different software, vendors, users, and clouds.

### SECTION 2.0 HISTORY OF RELATED ART

### References Cited

U.S. Patent Documents

| | | |
|---|---|---|
| 7,313,796 | December 2007 | Rick et al. |
| 7,439,937 | October 2008 | Ben-Shachar et al. |
| 7,529,785 | May 2009 | Spertus et al. |
| 7,596,620 | September 2009 | Colton et al. |
| 2001/0039497 A1 | November 2001 | Hubbard |
| 2004/0210591 A1 | August 2007 | Hirschfield et al. |
| 2004/0268347 A1 | December 2004 | Knauerhase et al. |
| 2006/0075042 A1 | April 2006 | Wang et al. |
| 2007/0226715 A1 | September 2007 | Kimura et al. |
| 2008/0080396 A1 | April 2008 | Henricus et al. |
| 2008/0080718 A1 | April 2008 | Henricus et al. |
| 2008/0215796 A1 | September 2008 | Lam et al. |
| 2009/0012885 A1 | January 2009 | Cahn |
| 2009/0099940 A1 | April 2009 | Frederick et al. |
| 2009/0177514 A1 | July 2009 | Hudis et al. |
| 2009/0210527 A1 | August 2009 | Kawato |
| 2009/0210875 A1 | August 2009 | Bolles |
| 2009/0271324 A1 | October 2009 | Jandhyala et al. |
| 2009/0300635 A1 | December 2009 | Ferris |
| 2010/0131590 A1 | May 2010 | Coleman et al. |
| 2010/0299366 A1 | November 2010 | Stienhans et al. |
| 2011/0016214 A1 | January 2011 | Jackson |
| 2011/0055399 A1 | March 2011 | Tung et al. |
| 2011/0145392 A1 | June 2011 | Dawson et al. |

### Publications

1. DeHaan et al., “Methods and Systems for Flexible Cloud Management Including External Clouds”, U.S. application Ser. No. 12/551,506, filed Aug. 31, 2009.
2. DeHaan et al., “Methods and Systems for Flexible Cloud Management with Power Management Support”, U.S. application Ser. No. 12/473,987, filed May 28, 2009.
3. DeHaan et al., “Methods and Systems for Flexible Cloud Management”, U.S. application Ser. No. 12/473,041, filed May 27, 2009.
4. DeHaan et al., “Systems and Methods for Power Management in Managed Network Having Hardware-Based and Virtual Reources”, U.S. application Ser. No. 12/475,448, filed May 29, 2009.
5. DeHaan et al., “Systems and Methods for Secure Distributed Storage”, U.S. application Ser. No. 12/610,081, filed Oct. 30, 2009.
6. DeHaan, “Methods and Systems for Abstracting Cloud Management to Allow Communication Between Independently Controlled Clouds”, U.S. application Ser. No. 12/551,096, filed Aug. 31, 2009.
7. DeHaan, “Methods and Systems for Abstracting Cloud Management”, U.S. application Ser. No. 12/474,113, filed May 28, 2009.
8. DeHaan, “Methods and Systems for Automated Migration of Cloud Processes to External Clouds”, U.S. application Ser. No. 12/551,459, filed Aug. 31, 2009.
9. DeHaan, “Methods and Systems for Automated Scaling of Cloud Computing Systems”, U.S. application Ser. No. 12/474,707, filed May 29, 2009.
10. DeHaan, “Methods and Systems for Securely Terminating Processes in a Cloud Computing Environment”, U.S. application Ser. No. 12/550,157, filed Aug. 28, 2009.
11. Ferris et al., “Methods and Systems for Cloud Deployment Analysis Featuring Relative Cloud Resource Importance”, U.S. application Ser. No. 12/790,366, filed May 28, 2010.
12. Ferris et al., “Methods and Systems for Converting Standard Software Licenses for Use in Cloud Computing Environments”, U.S. application Ser. No. 12/714,099, filed Feb. 26, 2010.
13. Ferris et al., “Methods and Systems for Detecting Events in Cloud Computing Environments and Performing Actions Upon Occurrence of the Events”, U.S. application Ser. No. 12/627,646, filed Nov. 30, 2009.
14. Ferris et al., “Methods and Systems for Generating Cross-Mapping of Vendor Software in a Cloud Computing Environment”, U.S. application Ser. No. 12/790,527, filed May 28, 2010.
15. Ferris et al., “Methods and Systems for Matching Resource Requests with Cloud Computing Environments”, U.S. application Ser. No. 12/714,113, filed Feb. 26, 2010.
16. Ferris et al., “Methods and Systems for Metering Software Infrastructure in a Cloud Computing Environment”, U.S. application Ser. No. 12/551,514, filed Aug. 31, 2009.
17. Ferris et al., “Methods and Systems for Pricing Software Infrastructure for a Cloud Computing Environment”, U.S. application Ser. No. 12/551,517, filed Aug. 31, 2009.
18. Ferris et al., “Systems and Methods for Brokering Optimized Resource Supply Costs in Host Cloud-Based Network Using Predictive Workloads”, U.S. application Ser. No. 12/957,274, filed Nov. 30, 2010.
19. Ferris et al., “Systems and Methods for Exporting Usage History Data as Input to a Management Platform of a Target Cloud-Based Network”, U.S. application Ser. No. 12/790,415, filed May 28, 2010.
20. Ferris, “Methods and Systems for Providing a Universal Marketplace for Resources for Delivery to a Cloud Computing Environment”, U.S. application Ser. No. 12/475,228, filed May 29, 2009.
21. Ferris, et al., “Systems and Methods for Combinatorial Optimization of Multiple Resources Across a Set of Cloud-Based Networks”, U.S. application Ser. No. 12/953,718, filed Nov. 24, 2010.
22. Morgan, “Systems and Methods for Generating Dynamically Configurable Subscription Parameters for Temporary Migration of Predictive User Workloads in Cloud Network”, U.S. application Ser. No. 12/954,378, filed Nov. 24, 2010.
23. Morgan, “Systems and Methods for Generating Marketplace Brokerage Exchange of Excess Subscribed Resources Using Dynamic Subscription Periods”, U.S. application Ser. No. 13/037,351, filed Feb. 28, 2011.
24. Morgan, “Systems and Methods for Generating Multi-Cloud Incremental Billing Capture and Administration”, U.S. application Ser. No. 12/954,323, filed Nov. 24, 2010.
25. Morgan, “Systems and Methods for Generating. Optimized Resource Consumption Periods for Multiple Users on Combined Basis”, U.S. application Ser. No. 13/037,359, filed Mar. 1, 2011.
26. Morgan, “Systems and Methods for Metering Cloud Resource Consumption Using Multiple Hierarchical Subscription Periods”, U.S. application Ser. No. 13/037,360, filed Mar. 1, 2011.

### SECTION 3.0 SUMMARY OF THIS INVENTION

An embodiment of the storage Marketplace comprises an assortment of storage spaces provided by third-party vendors together with local/on-premise storage added by resellers and companies and storage inherited thereof, if any, by downstream resellers and companies in the hierarchical topology network.

By installing the software agent developed by the applicant N2S on resellers and companies' computers and servers located in the hierarchical network topology, the storage Marketplace is made visible and accessible to such nodes.

This invention develops methods of creating a storage Marketplace through the process of installing the software agent on individual nodes in the hierarchical network topology. Resellers in these nodes have the choice of selecting one or many of their inherited storages for offer to their immediate downstream customers. Resellers possessing superior IT infrastructure, Service Level Agreement (SLA), bandwidth, storage quality, equipment et al. (these resellers are designated Service Providers) have the ability to restrict its immediate downstream customers from accessing directly the third-party vendor storage components of the Marketplace. Other resellers, which are not designated Service Providers, shall not be able to impose such restrictions on their immediate downstream customers from accessing directly the third party vendor storage components of the Marketplace.

This invention further develops methods of calculating and setting price plus margin in the storage Marketplace.

This invention further develops methods of allocating pricing and storage for a plurality of resellers and companies with scalability and diminution in the successive tiered hierarchy of the said resellers and companies set up in a logical tree network topology.

### SECTION 4.0 BRIEF DESCRIPTIONS OF THE DRAWINGS

The foregoing summary, as well as the following description of the invention, is better understood when read with the appended drawings. For the purpose of illustrating the invention, there is shown in the drawings exemplary embodiments of various aspects of the invention. The invention is however not limited to the specific disclosed methods and instrumentalities.

The definitions used in reference to the diagrams include: N2S is the applicant, Reseller 1 is a customer of N2S, Reseller 2 is a customer of Reseller 1, Company 1 is a customer of Reseller 1 and Company 2 is a customer of Reseller 2. {M1, M2, M3, M4, M5} is an assorted storage set comprising storage components provided by third-party vendors (Vendors) that conform to N2S qualification criteria. Service Provider 2 is a reseller providing superior IT infrastructure.

FIG. 1 illustrates a general embodiment of this invention where a topology is constructed with arbitrary hierarchy showing the applicant (N2S), two resellers (Reseller 1 and Reseller 2) and one company (Company 2). L and A are two local storages managed by N2S, where L is storage on N2S′ own on-premise infrastructure (e.g. local storage server) and A is storage purchased from third-party storage vendors. This storage is inherited logically and physically by the next node in the hierarchical topology by Reseller 1, who adds his own local storage R1 to the public cloud L+A made available by N2S. The same mechanism is repeated for Reseller 2, which then offers the public cloud storage to its end customer, Company 2. Company 2 can deploy any combination of its own local storage C2 and/or any of the inherited storages L+A+R1+R2.

FIG. 2 illustrates another general embodiment of this invention where a topology is constructed in consistence with FIG. 1, where an intermediate node in the topology downstream selects a particular permutation of the inherited tiered storage. As an example, Reseller 1 selects only storage A made available from N2S, while rejecting available storage L. This permutation is carried forward downstream through Reseller 2 to Company 2. Company 2 has the ability to choose any combination of its own local/on-premise storage C2 and/or any of the available inherited storage A+R1+R2.

FIG. 3 illustrates another general embodiment of this invention where a topology is constructed in consistence with FIG. 1, showing addition of extra local/on-premise storage by Company 2 (C2n). Company 2 has the ability to choose any combination of its own local/on-premise storage C2+C2n and/or any of the available inherited storage L+A+R1+R2.

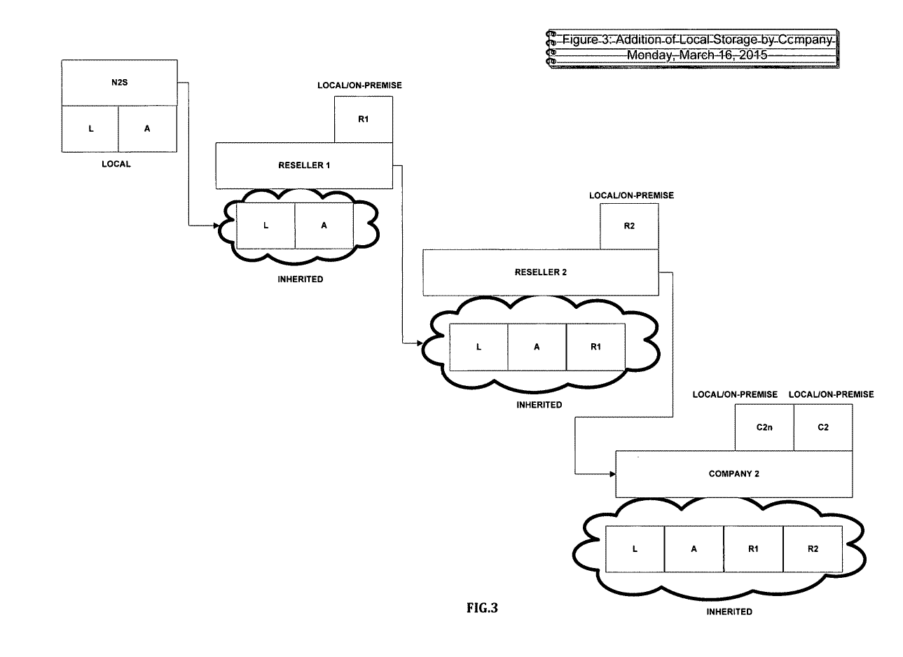

FIG. 4 illustrates another general embodiment of this invention where a topology is constructed in consistence with FIG. 1, showing the introduction of another company (Company 1) in the downstream topology managed by Reseller 1. The inherited tiered storage by Company 1 is as shown on the lines of the description of FIG. 1. Company 1 has the ability to choose any combination of its own local/on-premise storage C1 and/or any of the available inherited storage L+A+R1. Company 2 has the ability to choose any combination of its own local/on-premise storage C2 and/or any of the available inherited storage L+A+R1+R2.

FIG. 5 illustrates another general embodiment of this invention where a topology is constructed in consistence with FIG. 1, showing Reseller 1 rejection of the N2S storage L and A, while deploying its own local/on-premise storage R1, which it transfers downstream to its customers, Reseller 2 and Company 1. Reseller 2 inherits storage R1 from Reseller 1 and deploys its own local/on-premise storage R2, which it transfers downstream to its customer, Company 2. Company 2 has the ability to choose any combination of its own local/on-premise storage C2 and/or any of the available inherited storage R1+R2. Company 1, on the other hand, has the ability to choose any combination of its own local/on-premise storage C1 and/or any of the available inherited storage R1.

FIG. 6 is a storage pricing diagram derived from the general embodiment of this invention where a topology is constructed in consistence to FIG. 4. The $ figure in the topology vectors shows the amount of pricing margin added by the downstream entity in the topology network. As an example, Reseller 1 receives available inherited storage L+A from N2S at price $. It then adds margin while transferring downstream the storage L+A+R1, which Company 1 and Reseller 2 receives directly as direct customers of Reseller 1 at price $$. Reseller 2 further adds margin to this price, and Company 2, which is Reseller 2's direct customer, receives the inherited storage L+A+R1+R2 at price $$$.

FIG. 7 illustrates a greater general embodiment of this invention where a topology is constructed in consistence with FIG. 4, along with an assorted set of storage provided by third-party vendors (Vendors). Vendor-provided storage is typically unused storage in custody of a wide variety of organizations that have available space storage capacity but not utilizing it completely. Vendor-provided storage is made available universally to all nodes in the topology, i.e. all Resellers and Companies. A general embodiment illustrates the notion of inherited storage as shown in FIG. 7. Reseller 1 inherits storage L+A from N2S and directly sources storage MR1 from the storage set {M1, M2, M3, M4, M5} from the Vendors. Reseller 1 deploys its own local/on-premise storage R1. Reseller 1 then makes available this assorted storage downstream on the topology. Reseller 2, being a direct customer of Reseller 1, inherits the storage L+A+R1+MR1 from Reseller 1. It also directly sources storage MR2 from the storage set {M1, M2, M3, M4, M5} from the Vendors and adds its own local/on-premise storage R2. Company 1 is a direct customer of Reseller 1 and hence inherits the storage L+A+R1+MR1. Company 1 directly sources storage MC1 from the storage set {M1, M2, M3, M4, M5} from the Vendors. Company 1 can use any combination of its own local/on-premise storage C1, directly sourced storage MC1 from the Vendors and/or any inherited storage L+A+R1+MR1. Company 2 directly sources storage MC2 from the storage set {M1, M2, M3, M4, M5}. Company 2 can use any combination of its own local/on-premise storage C2, directly sourced storage MC2 from the Vendors and/or any inherited storage L+A+R1+R2+MR1+MR2.

FIG. 8 is a storage pricing diagram derived from the general embodiment of this invention in consistence with FIG. 7. The key concept illustrated through this diagram is the notion of price settings in the topology network. N2S is the topmost node in the topology, which makes available its local storage L+A at its immediate downstream node, Reseller 1, which is N2S′ direct customer, at price $N. Reseller 1, while transferring storage downstream to be inherited by its direct customers, Reseller 2 and Company 1, sets the price of the transferred storage at $RESELLER1. Similarly, Reseller 2, while transferring storage downstream to be inherited by its direct customers, Company 2, sets the price of the transferred storage at $RESELLER2. Company 1 obtains a price $MC1 when it sources storage MC1 directly from the Vendors. Company 2 obtains a price $MC2 when it sources storage MC2 directly from the Vendors. Both Company 1 and Company 2 can choose to purchase storage from the source depending on the prices it receives from the corresponding Reseller and the Vendors. The prices set by Resellers in the downstream topology are functions of the prices received directly from the immediate upstream node, which is then added margin to and transferred to companies downstream.

FIG. 9 illustrates the jurisdictional features of the Marketplace in consistence with FIG. 7. The Marketplace consists of a storage set {M1, M2, M3, M4, M5} that consist of physical storages, for example, located in {USA, UK, Australia, Germany, France} respectively. Reseller 1 is physically located in the USA and is expected to select storage MR1 from the Vendors that is a subset of storage M1 located physically in the USA, however it is not restricted from accessing storage located outside the USA, i.e. from storage sets M2, M3, M4 and M5. Company 1 is a direct customer of Reseller 1, also located in the USA, and while expected to source storage MC1 directly from storage set M1 but may also choose storage from storage sets M2, M3, M4 and M5. In this way, data in a particular country can be confined within that country's jurisdiction. Reseller 2 is a direct customer of Reseller 1, but is located in the UK. Reseller 2 inherits storage MR1 sourced by Reseller 1 from the Vendors even though Reseller 2 is located outside the USA. Reseller 2 inherits the available storage L+A+R1 from Reseller 1. Reseller 2 is expected to source storage MR2 from storage set M2 that consists of physical storage located in the UK but may also choose storage from storage sets M1, M3, M4 or M5. Company 2, located in France and a direct customer of Reseller 2, is expected to source storage MC2 from storage set M5, but may also choose storage from M1, M2, M3 or M4. This effectively means that through establishing the Marketplace, company data is managed and stored on the jurisdiction where it is domiciled, as opposed to being transferred to a physical storage located at a different jurisdiction.

FIG. 10 illustrates the case of a Service Provider in line with the concepts and principles described in this invention. Service Provider 2, due to its superior IT infrastructure, is able to offer MR2 to its immediate downstream customer Company 2, while restricting Company 2 to access MC2 from the Vendor-provided storage.

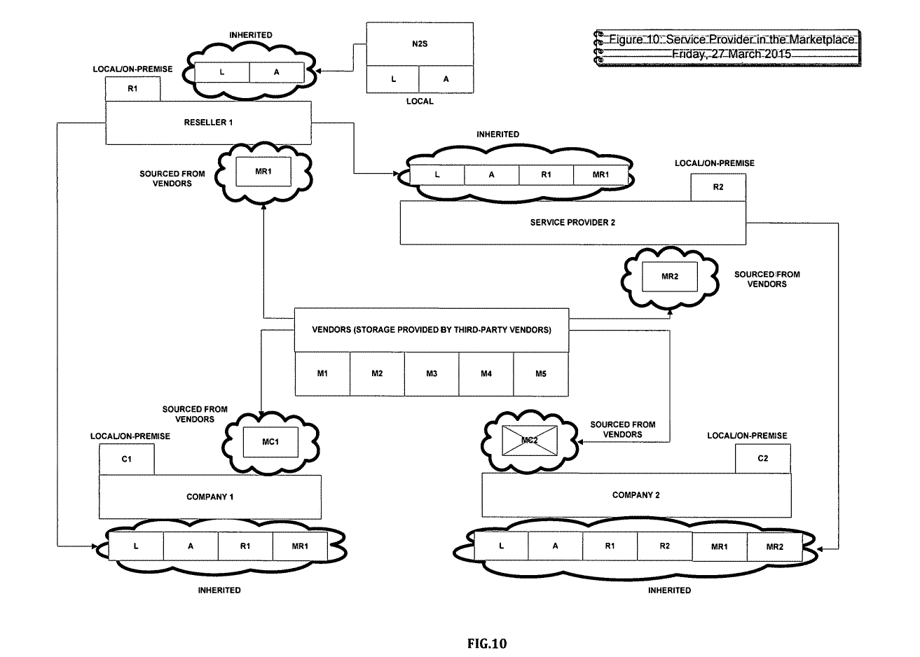

### SECTION 5.0 PRICING METHODOLOGIES

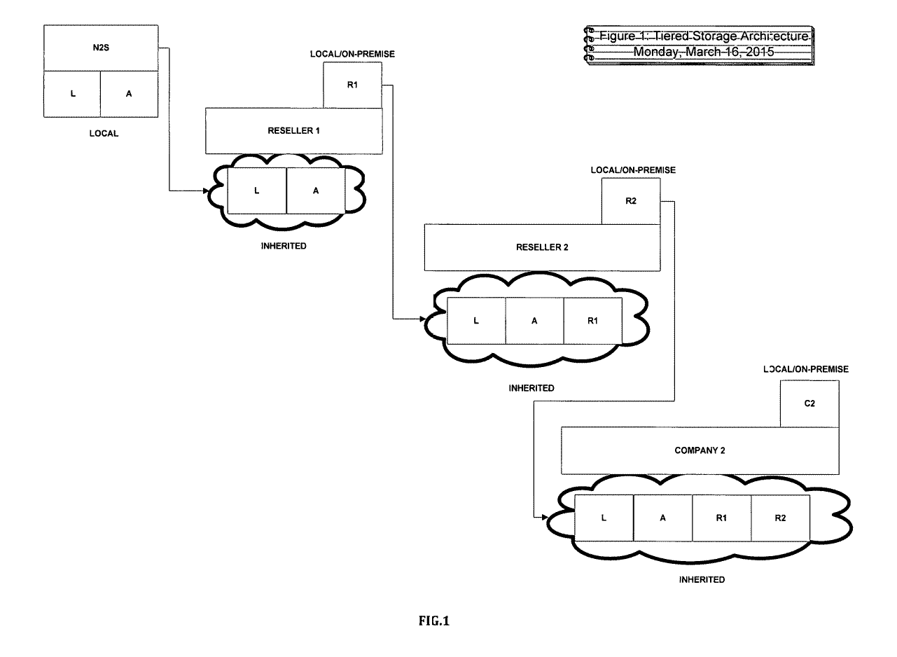

FIG. 1 shows the applicant N2S offering two local/on-premise storage options L and A, along with Reseller 1, Reseller 2 and Company 2 providing their own local/own-premise storage R1, R2 and C2 respectively. Margins are added to storage buy prices to establish storage sell prices as detailed in Table 1.

The nomenclature for the pricing scheme takes into consideration the source of the offered price prior to the $ pivot that succeeds the price associated with that source, i.e. R1R2$L means the sell price Reseller 1 offers storage L to Reseller 2.

TABLE 1
Pricing Table corresponding to the embodiment of FIG. 1

| | Storage available | Storage | Storage Sell Price |
|---|---|---|---|
| Entity | for on-sell | Buy Price | (including margin) |
| N2S | L | $L | N2S$L |
| N2S | A | $A | N2S$A |
| Reseller 1 | L | N2S$L | R1R2$L |
| Reseller 1 | A | N2S$A | R1R2$A |
| Reseller 1 | R1 | $R1 | R1R2$R1 |
| Reseller 2 | L | R1R2$L | R2C2$L |
| Reseller 2 | A | R1R2$A | R2C2$A |
| Reseller 2 | R1 | R1R2$R1 | R2C2$R1 |
| Reseller 2 | R2 | $R2 | R2C2$R2 |
| Company 2 | L | R2C2$L | |
| Company 2 | A | R2C2$A | |
| Company 2 | R1 | R2C2$R1 | |
| Company 2 | R2 | R2C2$R2 | |
| Company 2 | C2 | $C2 | |

It is to be noted that Reseller 1 may choose between its direct local/on-premise storage and the inherited storage from N2S based on price, jurisdiction and other performance criteria. At each level of the hierarchical network topology, commercial competitive pricing alternatives are introduced with these storage options available. Each Reseller or Company user can select the appropriate storage option based on price, jurisdiction and other performance criteria to suit their specific business needs.

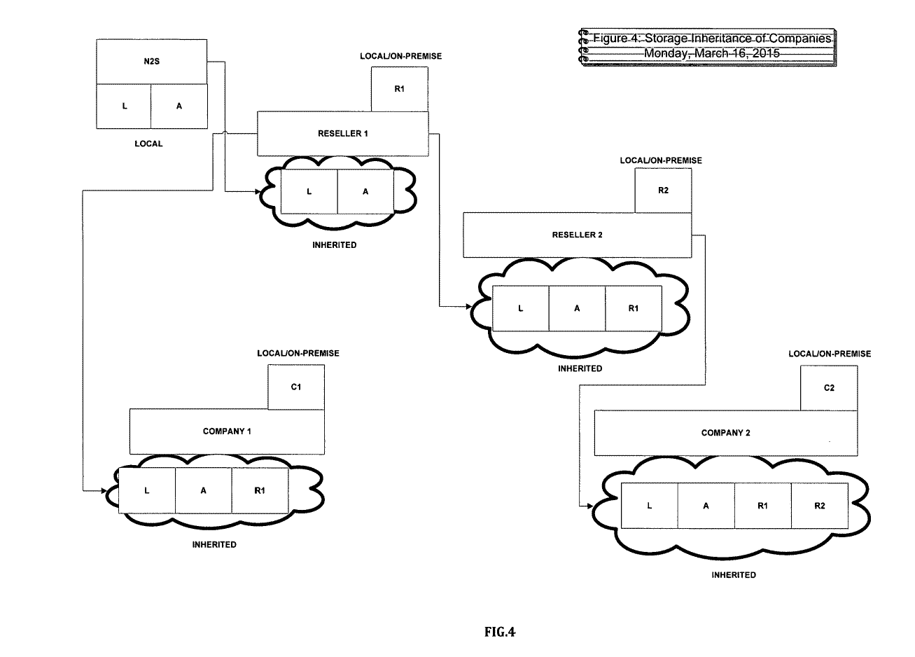

FIG. 4. introduces Company 1. Based on the pricing principles and nomenclature adopted for FIG. 1, the pricing scheme for the embodiment of FIG. 4 is shown in Table 2.

TABLE 2
Pricing Table corresponding to the embodiment of FIG. 4

| | Storage available | Storage | Storage Sell Price |
|---|---|---|---|
| Entity | for on-sell | Buy Price | (including margin) |
| N2S | L | $L | N2S$L |
| N2S | A | $A | N2S$A |
| Reseller 1 | L | N2S$L | R1R2$L (for Reseller 2), |
| | | | R1C1$L (for Company 1) |
| Reseller 1 | A | N2S$A | R1R2$A (for Reseller 2), |
| | | | R1C1$A (for Company 1) |
| Reseller 1 | R1 | $R1 | R1R2$R1 (for Reseller 2), |
| | | | R1C1$R1 (for Company 1) |
| Reseller 2 | L | R1R2$L | R2C2$L |
| Reseller 2 | A | R1R2$A | R2C2$A |
| Reseller 2 | R1 | R1R2$R1 | R2C2$R1 |
| Reseller 2 | R2 | $R2 | R2C2$R2 |
| Company 2 | L | R2C2$L | |
| Company 2 | A | R2C2$A | |
| Company 2 | R1 | R2C2$R1 | |
| Company 2 | R2 | R2C2$R2 | |
| Company 2 | C2 | $C2 | |
| Company 1 | L | R1C1$L | |
| Company 1 | A | R1C1$A | |
| Company 1 | R1 | R1C1$R1 | |
| Company 1 | C1 | $C1 | |

It is to be noted that with reference to FIG. 4, Reseller 1 has two direct customers, Reseller 2 and Company 1 at the same logical hierarchy level. Reseller 1 may choose to make all local/on-premise and inherited storage options available or limit these local/on-premise and inherited storage options offered to its direct customers.

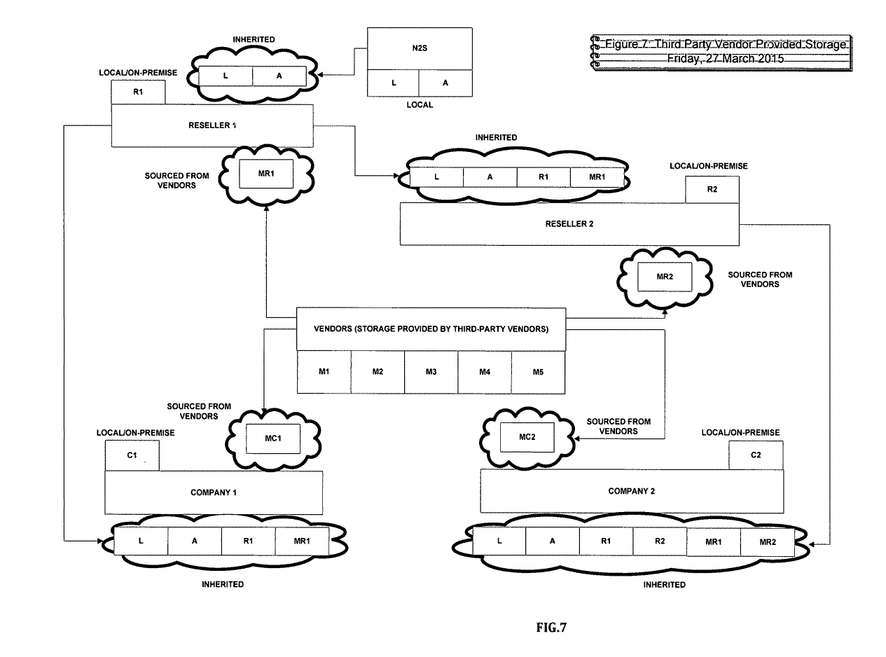

FIG. 7 introduces a universal storage marketplace where storage sets are made available to all nodes in the hierarchical network topology by the functioning and installation of the N2S software. Vendor-provided storage set {M1, M2, M3, M4, M5} are independently available separately for purchase, either in part or in entirety, depending on the configuration of the network topology and the policy of the downstream nodes in the said network topology. In this situation, all the nodes in the network topology are able to access the Marketplace and purchase storage from one or more of the storage sets based on local policy and amount of storage required. For example, the entire storage set {M1, M2, M3, M4, M5} is made available to Reseller 1, from which it selects storage MR1. MR1 may be chosen from any of the storage set elements among M1, M2, M3, M4, M5. Similar is the case for Reseller 2, Company 1 and Company 2, each can directly source storage from the Vendors described as MR2, MC1 and MC2 respectively from any of the storage set elements M1, M2, M3, M4, M5. Based on the principles and nomenclature adopted in pricing as outlined previously, the pricing scheme for the embodiment of FIG. 7 is shown in Table 3.

TABLE 3
Pricing Table corresponding to the embodiment of FIG. 7

| | Storage available | | Storage Sell Price (including |
|---|---|---|---|
| Entity | for on-sell | Storage Buy Price | margin) |
| N2S | L | $L | N2S$L |
| N2S | A | $A | N2S$A |
| Reseller 1 | L | N2S$L | R1R2$L (for Reseller 2), |
| | | | R1C1$L (for Company 1) |
| Reseller 1 | A | N2S$A | R1R2$A (for Reseller 2), |
| | | | R1C1$L (for Company 1) |
| Reseller 1 | R1 | $R1 | R1R2$R1 (for Reseller 2), |
| | | | R1C1$R1 (for Company 1) |
| Reseller 1 | MR1 | $MR1 (from Marketplace) | R1R2$MR1 (for Reseller 1), |
| | | | R1C1$MC1 (for Company 1) |
| Company 1 | L | R1C1$L | |
| Company 1 | A | R1C1$A | |
| Company 1 | R1 | R1C1$R1 | |
| Company 1 | C1 | $C1 | |
| Company 1 | MR1 | R1C1$MR1 | |
| Company 1 | MC1 | $MC1 (from Marketplace) | |
| Reseller 2 | L | R1R2$L | R2C2$L |
| Reseller 2 | A | R1R2$A | R2C2$A |
| Reseller 2 | R1 | R1R2$R1 | R2C2$R1 |
| Reseller 2 | MR1 | R1R2$MR1 | R2C2$MR1 |
| Reseller 2 | R2 | $R2 | R2C2$R2 |
| Reseller 2 | MR2 | $MR2 (from Marketplace) | R2C2$MR2 |
| Company 2 | L | R2C2$L | |
| Company 2 | A | R2C2$A | |
| Company 2 | R1 | R2C2$R1 | |
| Company 2 | R2 | R2C2$R2 | |
| Company 2 | MR1 | R2C2$MR1 | |
| Company 2 | MR2 | R2C2$MR2 | |
| Company 2 | C2 | $C2 | |
| Company 2 | MC2 | $MC2 (from Marketplace) | |

It is to be noted that due to pricing control, all resellers in the hierarchical network topology will receive a set of prices only set for resellers in the Marketplace. These prices will be different for companies who access the Marketplace to purchase storage. Typically, this will be controlled in the N2S software, website and/or web portal by filtering through the entity type upon registration of the entity at sign-up time. Reseller 1 thus has three potential prices to choose from while selecting storage, which is the cost to acquire its own local/on-premise storage R1, the cost to acquire storage available from Vendors MR1 and the cost to acquire inherited storage L+A from N2S. Reseller 1 will be able to select the appropriate storage spaces based on pricing, jurisdiction and other performance criteria as outlined previously. Then Reseller 1 can determine its sell prices of selected storage downstream to its immediate direct customers, Reseller 2 and Company 1. Similarly, each node in the hierarchical topology will have multiple prices to compare while choosing the storage space to purchase plus the price it needs to deploy its own local/on-premise storage, the price it receives from the Vendors and the price it receives from its inherited storage from upstream.

Resellers that possess superior bandwidth, robust high-grade IT infrastructure, SLA (Service Level Agreement), computing and storage equipment, secure data centres can be designated Service Providers. Service Providers have the ability to control the visibility and access of the Marketplace to its immediate customers downstream. In order to become a Service Provider, a reseller has to pay N2S a higher software license fee to enable restriction of accessing the Marketplace to its immediate customers downstream. As an example, if Reseller 2 is a Service Provider, it has the ability to stop storage MC2 being visible to its immediate customer downstream, Company 2. In this case, Company 2 cannot access the Marketplace directly, but only through an inherited storage that may be offered to it by Reseller 2.

Technically, there will be a maximum of two levels of separation in the Marketplace as shown in FIG. 7, with N2S at the highest level, Reseller 1 at the next level attached to Company 1 and Reseller 2, which is attached to Company 2. Typically, for vendors providing un-utilized storage to be deployed in the Marketplace, N2S will receive a commission and/or license fee from any quanta of storage sold amongst the nodes in the hierarchical network topology. The key point here is that through the creation of the Marketplace, N2S receives a commission and/or license fee from the vendors by deploying their un-utilized storage regardless of what prices are set by the resellers and the deploying storage vendors throughout the hierarchical network topology.

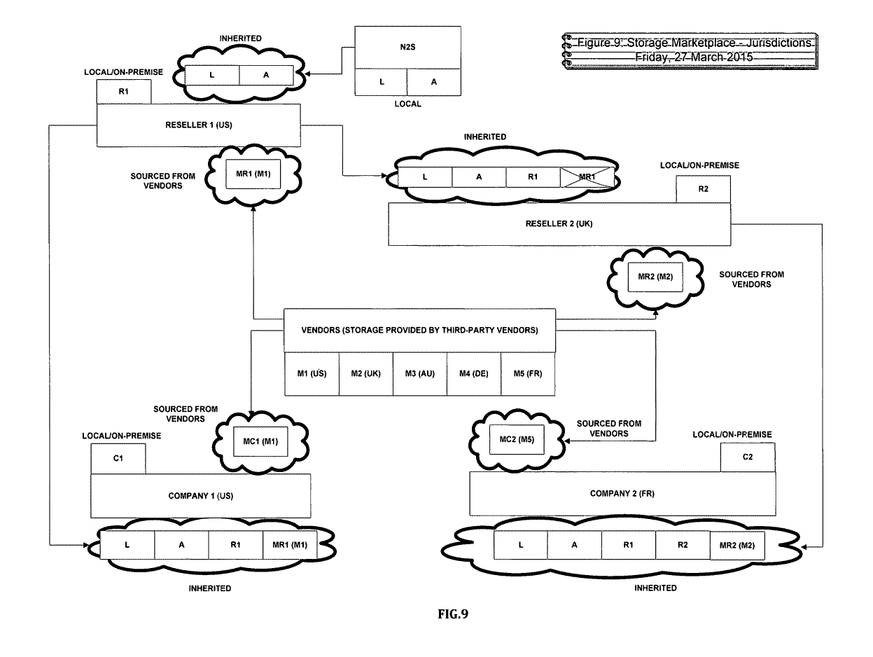

In case of FIG. 9, where jurisdiction is mentioned, the description for FIG. 7 is extended to a notion of scalability in the storage set {M1, M2, M3, M4, M5}. As shown in FIG. 9, M1 consists of a storage set in USA, M2 consists of a storage set in UK, M3 consists of a storage set in Australia, M4 consists of a storage set in Germany and M5 consists of a storage set in France. The set M1 can comprise of multiple physical storages provided by multiple vendors located in the USA, e.g. the set M1 can comprise a total of 1 PB of storage provided by multiple vendors located in the USA. Each vendor is likely to have different prices attached to their offered storages. Once this storage set M1 is made available to the Marketplace, Reseller 1 sees the vendor details, including but not limited to, their names, their locations, their available storage capacity, their bandwidth, their IT infrastructure and their attached prices. An important point to note here is that Reseller 1 may not always choose the cheapest price, preferring service quality, reliability and security of a vendor over another. $MR1 (as shown in Table 3) is thus set accordingly from this set. Similar is the case for $MR2, $MC1 and $MC2. Yet another notion is that a particular company can choose the location of its storage depending on a variety of factors such as cost, reliability and jurisdiction. As an example, Company 2 is located in France, accesses the entire Marketplace and is able to see the different storage offered by vendors across the globe, seeing vendors providing storage in UK, Australia, Germany and France, along with the vendors providing storage in the USA. Depending upon sensitivity of the data that Company 2 wishes to store, it can purchase storage space from any vendor at any of these five countries spanning over the entire storage set {M1, M2, M3, M4, M5}. Company 2 may select on jurisdiction for more sensitive data storage. In all the cases, any storage sold from the Marketplace will result in a commission and/or license fees being paid to N2S.

### SECTION 6.0 DETAILED DESCRIPTION OF THE INVENTION

### Section 6.1 Introduction

The subject matter of this invention is described with specificity to highlight the resolution of technical challenges faced in scalable multiple tiered storage during cloud file sharing and synchronization. This invention relates generally to methods for a cross-cloud vendor mapping service in a dynamic cloud marketplace, and more particularly, to platforms and techniques for allocating multiple storage to computing units arranged in a network topology. The record of multiple storage use across a dynamically shifting sequence of provisioning clouds selected from a set of marketplace clouds mediated by a cloud marketplace system is used as a basis of price setup. The description itself is not intended to limit the scope of this patent. The inventors have contemplated that the claimed subject matter might also be embodied in other ways, to include different steps or combinations of steps similar to the ones described in this document, in conjunction with other present or future technologies.

### Section 6.2 Deploying Environment

The general deploying environment of the embodiments of this invention is a network topology consisting of IT infrastructure connected through the internet running over TCP/IP, as commonly used in the networking terminology. The storage spaces in concern are general storage devices commonly used in storing data in network topologies (e.g. storage server, hard disks, NAS devices et al.)

### Section 6.3 Methods of Creating Marketplace

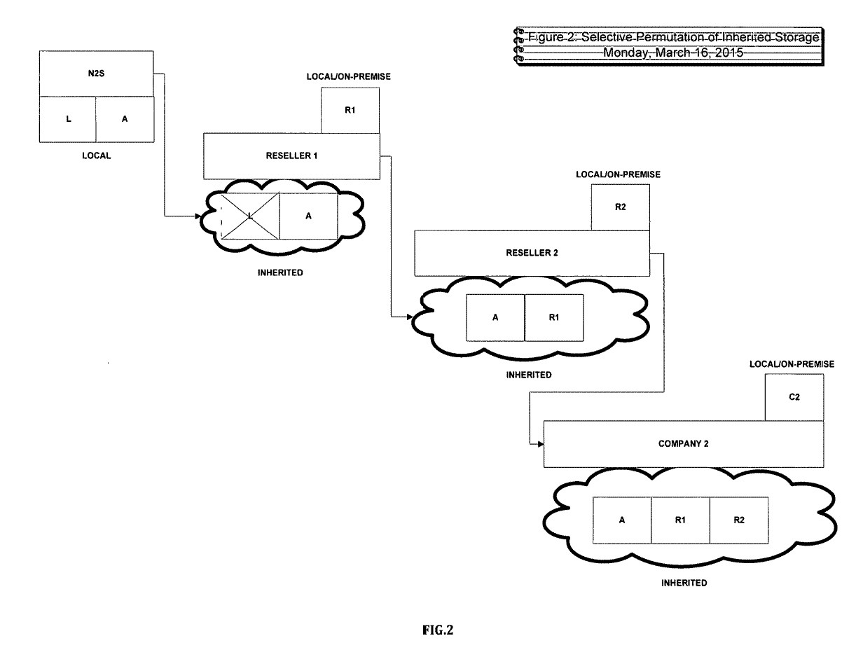

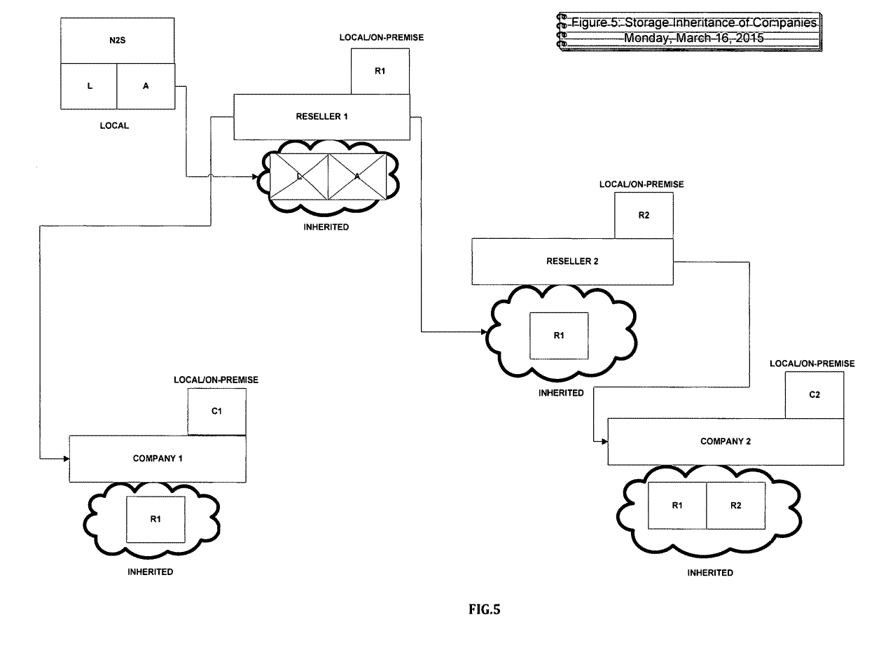

This invention is an associated invention by the applicant whereby a multi-tiered system having a vertical stack and horizontal tier elements for one or more levels of the stack to provide a dynamic and configurable system for storing data is described. This system provides an ability to automatically copy data in parallel to multiple classes or tiers of storage devices. These multiple tiers may include any type of storage infrastructure, including primary or secondary disk or solid-state storage system, data tape, power-managed arrays of disks and cloud-based storage. Users and IT administrators may decide how many of such backend systems would be utilized as well as managed, and provide information to define policies for the movement of data into, among, and from the backend systems and tiers of storage devices. This system manages the data by these set policies and determines how long the data will stay in each medium, be migrated between mediums, and otherwise managed. When a user retrieves data, this system determines which data storage source would best suit the user's request. The system identifies which medium the data is stored in and will recall the data from the medium available that can deliver within the shortest period of time or otherwise meet the user's needs. This is embodied in the selective permutation of inherited tiered storage as illustrated in FIG. 2 and FIG. 5.

According to an embodiment of this disclosure illustrated in FIG. 1 and FIG. 4, a method for maintaining an index in multi-tier data structure includes providing a plurality of storage devices forming the multi-tier data structure, caching a list of key-value pairs stored on one or more tiers of the multi-tier data structure as a plurality of sub-lists according to a caching method, wherein each of the key-value pairs includes a key, and either a data value, a data pointer, the key-value pairs stored in the multi-tier data structure, providing a journal for interfacing with the multi-tier data structure, providing a plurality of block allocators recording which blocks of the multi-tier data structure are in use, and providing a plurality of zone managers for controlling access to blocks within individual tiers of the multi-tier data structure through the journal and block allocators, wherein each zone manager maintains a header object pointing to data to be stored in all allocated blocks.

A database service that implements a multi-tenant environment typically partitions data across multiple storage nodes and co-locates tables that are maintained on behalf of different customers together (e.g., on the same storage nodes and/or in the same database instance). A database service that implements a single-tenant environment isolates the tables it maintains on behalf of different clients from each other (e.g., maintaining them on different storage nodes and/or in different database instances).

As noted above, a database service that implements a multi-tenant environment would typically partition data across multiple storage nodes and co-locate tables that are maintained on behalf of different customers together (e.g., on the same storage nodes and/or in the same database instance). A multi-tenant database service would typically handle security, quality of service compliance, service level agreement enforcement, service request metering, and/or other table management activities for the tables it hosts for different clients collectively. This multi-tenant model tends to decrease the cost of database service for customers, at least in the aggregate. However, if a client desires to receive database services in a very high-scale use case (e.g., one in which the client requires a throughput of 1 million reads per second and/or 1 million writes per second), a single-tenant model may be more cost effective for the client than a multi-tenant environment. For example, including the functionally required to support multi-tenancy and to provide security, compliance/enforcement, and/or metering operations in the system may constrain (e.g., decrease) the amount of throughput that the system may be able to achieve for individual storage nodes.

One embodiment of a method for creating database instances and database tables in multi-tenant environments and in single-tenant environments is illustrated in FIG. 1, FIG. 2 and FIG. 4, showing N2S, Reseller 1, Reseller 2, Company 1 and Company 2. The method may include receiving a request to create a database instance in a system that provides database services in multi-tenant environments and in single-tenant environments. In some embodiments, the request may specify the environment type (e.g., multi-tenant or single-tenant). In other embodiments, the selection of an environment type in which to create a requested database instance may be based on a pre-determined policy specifying a default or initial selection for database instances created in the database system. As illustrated in FIG. 1, in response to the request, the method may include the database system (or a module thereof) creating a database instance in the specified type of environment. The method may also include the system receiving a request to create another database instance, where this other request specifies the other environment type (e.g., multi-tenant or single-tenant). In response to the request, the database system (or a module thereof) may create a database instance in the other type of environment. The storage spaces are thus mapped, creating the universal set from where the permutations of the selected tiered storages may occur.

When the request to instantiate a set of virtual machines or other resources has been received and the necessary resources to build those machines or resources have been identified, N2S can communicate with one or more set of resource servers to locate resources to supply the required components. In embodiments, other hardware, software or other resources not strictly located or hosted in one or more clouds can be accessed and leveraged as needed. For example, other software or services that are provided outside of one or more clouds acting as hosts, and are instead hosted by third parties outside the boundaries of those clouds, can be invoked by in-cloud virtual machines or users. For further example, other non-cloud hardware and/or storage services can be utilized as an extension to the one or more clouds acting as hosts or native clouds, for instance, on an on-demand, subscribed, or event-triggered basis. With the resource requirements identified for building a network of virtual machines, N2S can extract and build the set of virtual machines or other resources on a dynamic, on-demand basis. For example, one set of resource servers may respond to an instantiation request for a given quantity of processor cycles with an offer to deliver that computational power immediately and guaranteed for the next hour or day. A further set of resource servers can offer to immediately supply communication bandwidth, for example on a guaranteed minimum or best-efforts basis, for instance over a defined window of time. In other embodiments, the set of virtual machines or other resources can be built on a batch basis, or at a particular future time.

As shown in FIG. 4, N2S can further store, track and manage each user's identity and associated set of rights or entitlements to software, hardware, and other resources. Each user that operates a virtual machine or service in the set of virtual machines in the cloud can have specific rights and resources assigned and made available to them, with associated access rights and security provisions. N2S can track and configure specific actions that each user can perform, such as the ability to provision a set of virtual machines with software applications or other resources, configure a set of virtual machines to desired specifications, submit jobs to the set of virtual machines or other host, manage other users of the set of instantiated virtual machines or other resources, and/or other privileges, entitlements, or actions. N2S associated with the virtual machines of each user can further generate records of the usage of instantiated virtual machines to permit tracking, billing, and auditing of the resources and services consumed by the user or set of users. In aspects of this principle, the tracking of usage activity for one or more user (including network level user and/or end-user) can be abstracted from any one cloud to which that user is registered, and made available from an external or independent usage tracking service capable of tracking software and other usage across an arbitrary collection of clouds, as described herein. In embodiments, N2S of an associated cloud can for example meter the usage and/or duration of the set of instantiated virtual machines, to generate subscription and/or billing records for a user that has launched those machines. In aspects, tracking records can in addition or instead be generated by an internal service operating within a given cloud. Other subscription, billing, entitlement and/or value arrangements are possible.

In embodiments, more than one set of virtual machines can be instantiated in a given cloud at the same time, at overlapping times, and/or at successive times or intervals. N2S can, in such implementations, build, and launch and manage multiple sets of virtual machines as part of the set of instantiated virtual machines based on the same or different underlying set of resource servers, with populations of different virtual machines such as may be requested by the same or different users. N2S can institute and enforce security protocols in one or more clouds hosting one or more sets of virtual machines. Each of the individual sets or subsets of virtual machines in the set of instantiated virtual machines can be hosted in a respective partition or sub-cloud of the resources of the main cloud. The cloud management system of one or more clouds can for example deploy services specific to isolated or defined sub-clouds, or isolate individual workloads/processes within the cloud to a specific sub-cloud or other sub-domain or partition of the one or more clouds acting as host. The subdivision of one or more clouds into distinct transient sub-clouds, sub-components, or other subsets which have assured security and isolation features can assist in establishing a multiple user or multi-tenant cloud arrangement. In a multiple-user scenario, each of the multiple users can use the cloud platform as a common utility while retaining the assurance that their information is secure from other users of the same one or more clouds. In further embodiments, sub-clouds can nevertheless be configured to share resources, if desired.

In the foregoing and other embodiments, the user making an instantiation request or otherwise accessing or utilizing the cloud network can be a person, customer, subscriber, administrator, corporation, organization, government, and/or other entity. In embodiments, the user can be or include another virtual machine, application, service and/or process. In further embodiments, multiple users or entities can share the use of a set of virtual machines or other resources.

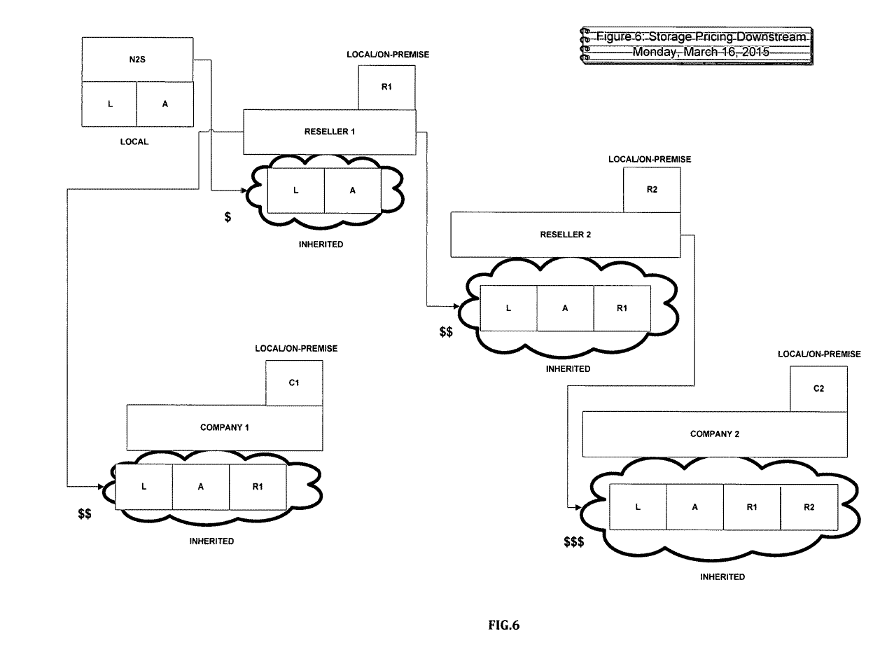

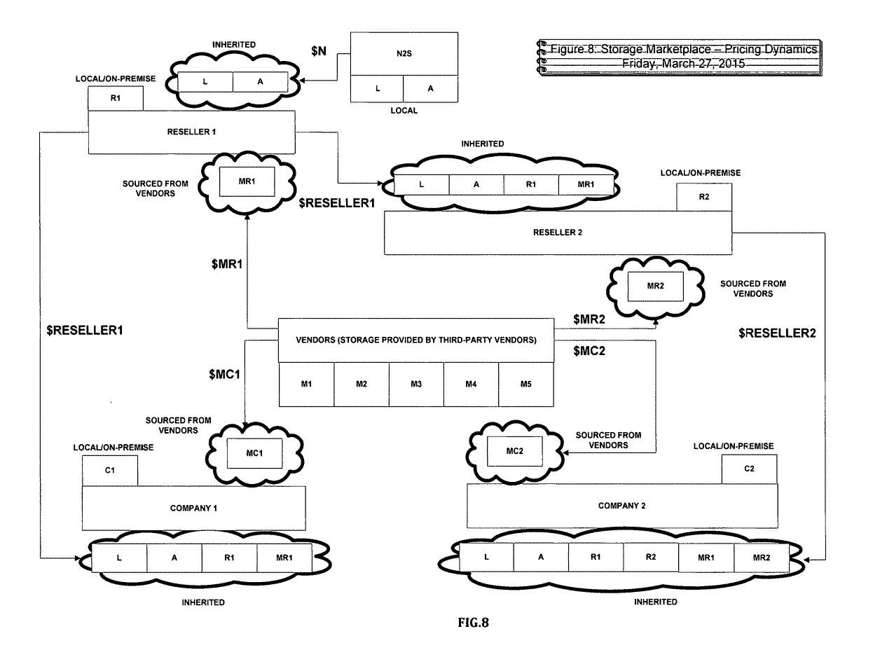

FIG. 6 and FIG. 8 demonstrate systems and methods for a cross-cloud vendor mapping service in a dynamic cloud marketplace that is made visible and accessible by installing a software agent developed by N2S on the individual IT infrastructure of resellers and companies in the hierarchical topology network. In embodiments as shown, a user can operate a client to generate a software specification request. In aspects, the user can select one or more applications, appliances, operating systems, components thereof, and/or other software to request to be installed and run on the client, and specify that selected software in the software specification request. In aspects, the client can be a virtual machine, and can for instance be maintained or instantiated in a cloud-based network. In aspects, the user can transmit the software specification request to a cloud marketplace system via one or more networks, to request that the cloud marketplace system receive, decode, and fulfil the software specification request by interacting with a set of marketplace clouds.

In general, the set of marketplace clouds can comprise a set of cloud-based networks configured to communicate with the cloud marketplace system, and respond to requests for software and/or other resources, such as the software specification request. In aspects, one or more of the clouds in the set of marketplace clouds can respond to the software specification request when notified by the cloud marketplace system by generating a set of fulfilment bids, and transmitting the set of fulfilment bids to the cloud marketplace system. In aspects, the set of fulfilment bids can be or include an indication of the availability of an application and/or other software resource, the version of that software, the number of instances of that software that the offering cloud can deliver, a timer period over which the software can be made available, a subscription cost and/or other cost for the delivery and use of the software, and/or other information. In aspects, the cloud marketplace system can receive the set of fulfilment bids from one or more cloud-based networks in the set of marketplace clouds, and can receive and store all such responses from the set of marketplace clouds. In aspects, the cloud marketplace system can be configured with decision logic to selected one or more clouds in the set of marketplace clouds to deliver and install software satisfying the software specification request, such as, for instance, logic which selects the set of fulfilment bids promising to deliver at least the minimum application requirements that may be specified in the software specification request, and at the lowest subscription cost. Other decision criteria can be used by the cloud marketplace system, and in embodiments, the cloud marketplace system can query the user of client to receive a selection of the set of fulfilment bids, if more than one bid or offer is received or selected.

After selection of the set of fulfilment bids satisfying the software specification request and otherwise identified for selection, the cloud marketplace system can register that set of cloud-based networks chosen to provision the requested software. In accordance with this principle, the cloud marketplace system can also register the selected cloud-based networks in the set of marketplace clouds chosen to provision the requested software to the cross-cloud vendor mapping service. In aspects, the cross-cloud mapping service can establish, build, and maintain a cross-cloud usage database that can access, extract, and/or record the usage history data for the software delivered from the one or more clouds of the set of marketplace clouds chosen to provision the user's requested software. The cross-cloud usage database can record the application and/or other software name or other ID, version, usage times, usage durations, and/or other information related to the user's use of the selected software, once that software has been provisioned by the set of marketplace clouds. In aspects, it may be noted that the cloud-based networks in the set of marketplace clouds selected to deliver the user's selected software can change over time. The dynamic nature of the particular cloud-based networks used to provision the user's selected software can be due to a variety of factors, including, for instance, the delivery of updated versions of the set of fulfilment bids from the set of marketplace clouds. When the set of fulfilment bids is updated, different cloud-based networks in the set of marketplace clouds may offer or bid to deliver the selected software and/or related resources under different or updated terms, leading to a reselection of the cloud-based networks in the set of marketplace clouds to be used to provision the client and/or other machines. In aspects, the cross-cloud mapping service can automatically continue to track the usage of the user's selected software in the set of marketplace clouds, across the dynamic progression of different provisioning clouds in the set of marketplace clouds without a need to reset or re-register the user, the client, the cloud marketplace system, and/or other parameters related to the tracking of the user's software consumption.

The cloud marketplace system can receive the set of fulfilment bids from those cloud-based networks in the set of marketplace clouds wishing to respond to the software specification request. The cloud marketplace system can select an initial set of provisioning clouds in the software specification request, based on the software specification request, the set of fulfilment bids, and/or other data. The cross-cloud mapping service can be invoked and/or instantiated via the cloud marketplace system. The cross-cloud mapping service can track, register, store, and/or record the user's software usage in the software specification request to the usage aggregation table of the cross-cloud usage database, and/or to other local or remote data stores. The cloud marketplace system can re-select, re-configure, and/or otherwise update or adjust the software specification request based on an updated set of fulfilment bids, an updated software specification request, and/or other parameters. The cross-cloud mapping service can continue the tracking and/or recording of the client's software usage in the software specification request, and can aggregate the client software usage history across varying sets of provisioning clouds in the software specification request for the user. The cross-cloud mapping service can generate a client software usage history report, a billing and/or subscription record, and/or other output for the user based on the data in the usage aggregation table and/or other sources, that data being aggregated across the software specification request.

The foregoing description is illustrative, and variations in configuration and implementation may occur to persons skilled in the art. While embodiments have been described in which one cross-cloud vendor mapping service operates to access, track, and manage the usage history including the profile of a user's consumption of software and hardware resources in the host cloud, in embodiments, multiple usage exporting services can operate and cooperate to maintain and transfer usage data on a cross-cloud, cross-vendor, or other basis. Other resources described as singular or integrated can in embodiments be plural or distributed, and resources described as multiple or distributed can in embodiments be combined. The scope of the invention is accordingly intended to be limited only by the listed claims.

1. Methods of creating a storage marketplace during inheritance of multiple storages and selective permutation of inherited storage thereof among a plurality of resellers set up in a logical tree network topology.

2. Methods of calculating and setting price information during inheritance of multiple storages and selective permutation of inherited storage thereof from the created marketplace among a plurality of resellers and companies set up in a logical tree network topology, as derived from claim 1.

3. Methods of allocating pricing and storage for a plurality of resellers and companies with scalability and diminution in the successive tiered hierarchy of the said resellers and companies set up in a logical tree network topology, as derived from claim 1.
